(19) United States
(12) Patent Application Publication
(10) Pub. No.: US 2009/0110524 A1
(43) Pub. Date: Apr. 30, 2009

(54) DELIVERY SYSTEM FOR UNLOADING AGGREGATE MATERIAL FROM A VEHICLE AND METHOD

(76) Inventor: Mark A. Hoffmann, Waterloo, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/928,974

(22) Filed: Oct. 30, 2007

(51) Int. Cl. B60P 1/36

(52) U.S. Cl. 414/507; 414/813

(57) ABSTRACT

A land vehicle for transporting and distributing aggregate material has an opening formed in the floor portion of a cargo area. A funnel rotatably connected to a bottom side of the floor portion beneath the opening communicates with a receiving end of a boom having a conveyor. The boom is hingeably connected to the funnel and fully stowable beneath the floor portion of the chassis when not in use. During operation, the boom is rotated outward by the funnel and is extended upward. A flow of aggregate material enters the funnel through the opening in the floor portion and is transferred off the vehicle by the conveyor.

### FIELD OF THE INVENTION

This invention generally relates to land vehicles, including but not limited to systems for unloading cargo carried by the vehicles.

### BACKGROUND

Land vehicles are commonly used for transportation of aggregate materials. For example, materials such as seed for planting crops may be transported over large distances between a distributor and a client by trucks travelling on public highways. Typically, seed is packaged in bags arranged on pallets or contained within large plastic bins loaded onto trucks by forklifts for distribution to customers. When a customer purchases seed from a distributor, the packaged seed is typically loaded onto a truck or band (or semi) trailer for transportation. Once the seed arrives at its destination, the pallets or bins are unloaded from the truck for use in the field.

After the seed has been unloaded, the aggregate seed material is taken out of its packaging and reloaded onto farm carts having conveyor delivery systems capable of gradually unloading the aggregate onto an advancing seed planting machine. One example of such a farm cart is described in U.S. Pat. No. 5,888,044 titled “Seed Cart With Loading/Unloading Conveyor System,” issued to G. Baskerville on Mar. 30, 1999.

This method of handling aggregate seed material and other similar materials, for example, grain or feed, is effective for transportation from the source to the user. However, the successive loading and unloading of the aggregate, as well as the removal of the aggregate from its packaging for transportation by cart to the site of use in the field, are both time consuming and wasteful (inasmuch as some of the aggregate is lost during the various loading and unloading procedures).

### BRIEF SUMMARY OF THE INVENTION

The disclosure describes, in one aspect, a land vehicle capable of transporting and unloading aggregates via a conveyor system. The conveyor is included in a moveable boom that can be stowed completely within the side edges of the vehicle. The aggregate is typically packaged in bags or large bins loaded onto the vehicle with a forklift. The vehicle has an opening formed in the floor portion of a cargo area. A funnel rotatably connected to a bottom side of the floor portion, beneath the opening, communicates with a receiving end of a boom having a conveyor. The boom is hingeably connected to the funnel and stowable completely beneath the floor portion of the chassis when not in use. During operation, the boom is extended and a flow of aggregate material enters the funnel through the opening in the floor portion, where it is transferred off the vehicle by the conveyor. The delivery system, including the funnel and boom, is advantageously modular and suited for connection to any type of vehicle, including rail cars. Moreover, placement of the delivery system beneath the floor of the vehicle provides a flat work surface around the opening such that a multitude of packaging forms for the aggregate can be used.

In another aspect, the disclosure provides a method for unloading aggregate material from a land vehicle. The method includes rotating a funnel rotatably connected to a floor portion of the vehicle about a vertical axis. The boom pivots with respect to the funnel to a desired material deposition location adjacent to the vehicle. The conveyor is activated and a flow of aggregate passes through an opening formed in the floor portion of the vehicle into the funnel, routed to a receiving end of the boom such that the flow of aggregate falls onto the conveyor, and transported along the conveyor to a delivery end of the boom.

### BRIEF DESCRIPTION OF THE SEVERAL VIEWS OF THE DRAWINGS

FIG. 1 is a side view of a truck having a delivery system connected to the bottom of a band trailer in accordance with the disclosure.

FIG. 2 is a top view of a truck having a delivery system in accordance with the disclosure.

FIG. 3 is a partial breakaway view of a trailer having a delivery system at a service position in accordance with the disclosure.

FIG. 4 is a partial breakaway view of a trailer having a delivery system in a stowed position in accordance with the disclosure.

FIG. 5 is a partial cross section of a trailer from the side, the trailer having a delivery system and related mechanical components connected to the bottom of the floor of the trailer in accordance with the disclosure.

FIG. 6 is a diagram for a hydraulic circuit for use with the delivery system in accordance with the disclosure.

FIGS. 7-9 are examples of different vehicles having delivery system(s) associated therewith in accordance with the disclosure.

### DETAILED DESCRIPTION

The present disclosure describes, in one aspect, a delivery system for use with a flat-bedded vehicle, for example, a truck, trailer, band trailer, or rail car. The delivery system is advantageously configured for directly unloading an aggregate material carried by the vehicle in a multitude of packaging configurations. The delivery system is well suited for applications requiring unloading of the aggregate by conveyor or, in general, gradual unloading of the aggregate while the vehicle is in motion. The embodiments described herein use an application for transporting aggregate seed for planting for illustration and by way of example but, as can be appreciated, the apparatus and methods described herein may be used for any other type of aggregate material.

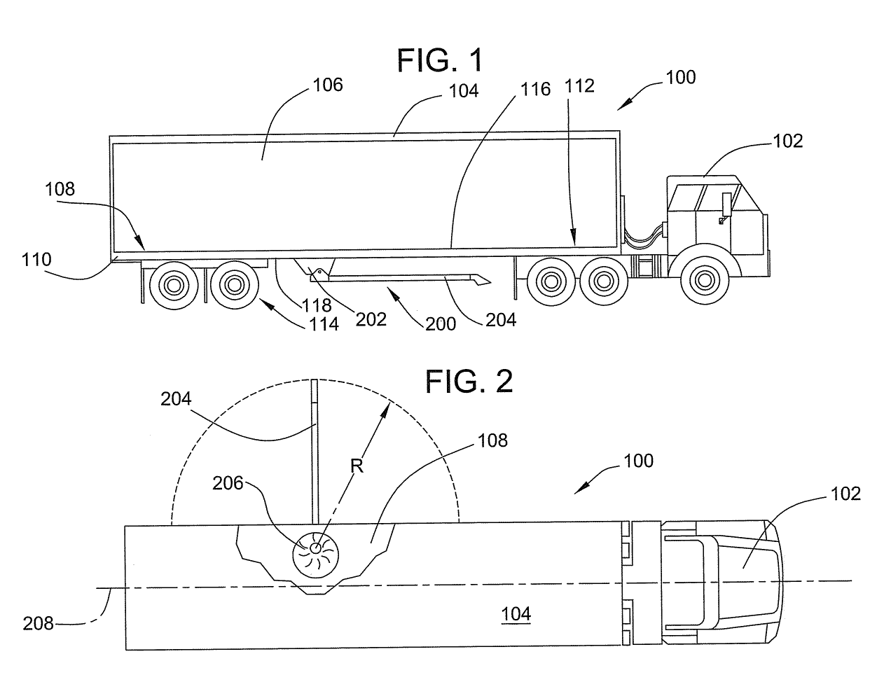

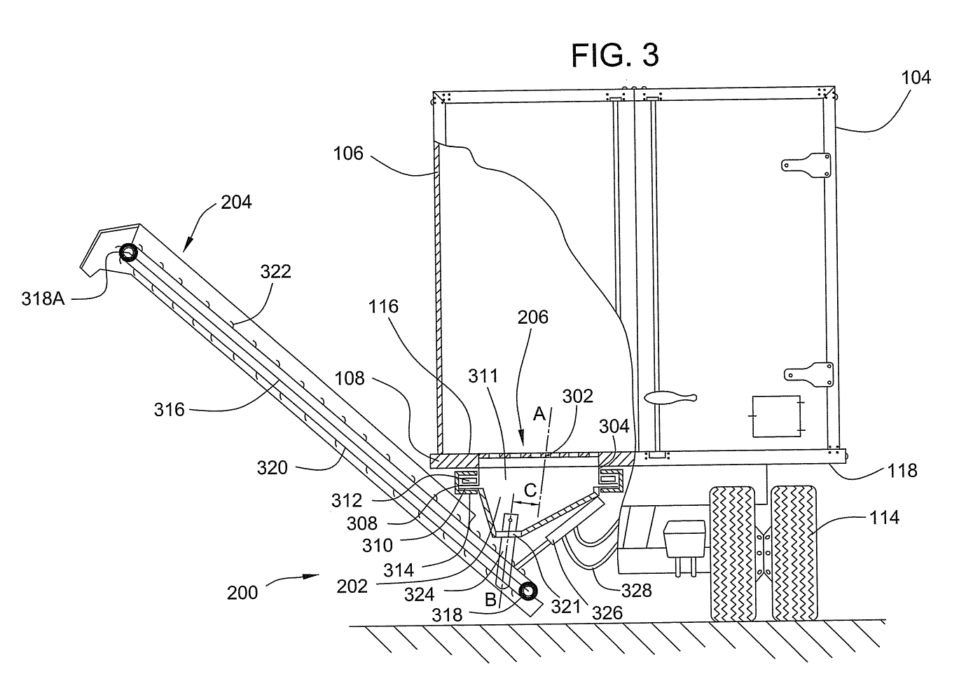

A side view of a truck 100 comprising a cab 102 and band trailer 104 is shown in FIG. 1, with a top view shown in FIG. 2. The band trailer 104 is enclosed by a shell 106 covering a floor portion 108. The floor portion 108 is part of a frame 110 having a hinge 112 connected to the cab 102 and wheels 114. The floor 108 has a top or deck side 116 enclosed by the shell 106, and a bottom side 118. The deck 116 is generally flat to allow for ingress of forklifts during loading. As can be appreciated, the truck 100 is suited for travel on public roads and highways and is capable of carrying cargo requiring protection from the weather or other road conditions.

A delivery system 200 is connected on the bottom side 118 of the floor 108 between the wheels 114 and the hinge 112. In general, the delivery system 200 may be connected anywhere along the bottom of the trailer 104 between features supporting or dragging the trailer along. The delivery system includes two main portions, a funnel portion 202 connected to the trailer 104, and a boom portion 204 pivotally connected to the funnel 202. As can be seen in the partial cutaway of FIG. 2, the funnel 202 is positioned below an opening 206 formed in the floor 108. The opening is located on one side of the centerline 208 of the truck 100, which extends along the center of the vehicle. The position of the funnel 202 closer to the side of the trailer 204 allows for greater reach of the boom 204 during operation. As shown by the dashed line semicircle, the boom 204 can swing out from the side of the trailer 104 when an operator so desires, and deposit aggregate material carried by the truck 100 anywhere within an area covering a segment of a circle having a radius, R, where R is the length of the boom 204. The boom 204 can also pivot about the funnel 202 such that the service range of the boom 204 might be reduced as the boom 204 is tilted upward. The boom 204 can be swung completely beneath the trailer 104 such that no portion thereof extends beyond the side of the trailer 104 when not in use.

A partial breakaway of the trailer 104, from a rear perspective, is shown in FIG. 3. The opening 206 in the floor 108 may include a grate 302 to protect against falling objects. An annular flange 304 having a ledge 308 is connected to the bottom side 118 of the floor 108 surrounding the opening 206. The ledge 308 extends perpendicularly therefrom and surrounds the opening 206. The funnel 202 forms a rim 310 around a mouth opening 311 corresponding to the ledge 308. A bushing ring 312 is disposed over the ledge 308, and a clamp or collar 314, having a “C” cross section, encircles the ledge 308, rim 310, and bushing ring 312. The collar 314 may comprise two halves, each half having a semicircular outline, that are hinged on one side thereof and that have a clamping mechanism securing them together on another side thereof, such that, when connected, the two halves of the collar 314 extend substantially around the rim 310. As can be appreciated, other configurations are possible for slideably connecting the ledge 308 with the rim 310, for example, at least three angled elements symmetrically disposed around the periphery of the rim 310 and connected to the trailer 104 may both isostatically support the funnel 204 and allow for sliding motion between the rim 310 and ledge 308. With the clamp 314 installed, the funnel 204 is rotatably connected to the ledge 308 of the annular flange 304. The bushing ring 312 provides a sliding interface to reduce friction between the clamp 314 and the ledge 308.

The funnel 204 is advantageously offset to permit a greater range of tilting motion and improved reach for the boom 204 relative to the sides of the band trailer 104. More specifically, a centerline, A, of the mouth opening 311 is offset from a centerline, B, of the spout opening 321 by a distance, C. As can be appreciated, the offset distance C will bring the spout opening 321 of the funnel 204 closer to the edge of the trailer 104 when the funnel 204 is rotated. By positioning the spout opening 321 closer to the edge of the trailer 104, the range of motion of the boom 204 is increased, and the distance within which the boom 204 may extend and deposit material is increased.

The boom 204, shown here in cross section, includes a support structure 316 rotatably supporting rollers 318 on either end. One of the rollers 318 may be free rolling and the other may be powered by a motor (not shown). In the embodiment presented, the roller 318A disposed on the distant end of the boom 204 is connected to a motor acting to rotate the roller 318A and advance a conveyor belt 320. The conveyor 320 is capable of motion along the length of the boom 204 and may be any type of conveyor belt known. Selection of an appropriate type should be made according to the type of aggregate material being transferred; in the case of aggregate seed material, for example, a conveyor made of nylon and/or wire reinforced rubber belting material having “scoop” protrusions 322 formed along its length may be selected to promote efficient motion of the aggregate along the boom 204.

A pair of support hinges 324 pivotally connect the support structure 316 of the boom 204 to the funnel 202 such that the conveyor belt 320 is located beneath the spout opening 321 of the funnel 202. Each support hinge 324 advantageously allows pivoting motion of the boom 204 with respect to the funnel 202. Motion of the boom 204 is controlled by a hydraulic cylinder 326 connected between the funnel 202 and the support structure 316. The cylinder 326 is one of many examples of linear actuators suitable for pivoting the boom 204. Other examples of linear actuators include pneumatic pistons, electrical solenoids, rack and pinion drives, and so forth. In the embodiment shown, the cylinder 326 receives hydraulic fluid under pressure from a fluid supply line or hose 328, which acts to selectively extend or retract the cylinder 326. As the cylinder 326 extends, the support structure 316 pivots around the support hinges 324 to raise the boom 204. Conversely, retraction of the cylinder 326 lowers the boom 204.

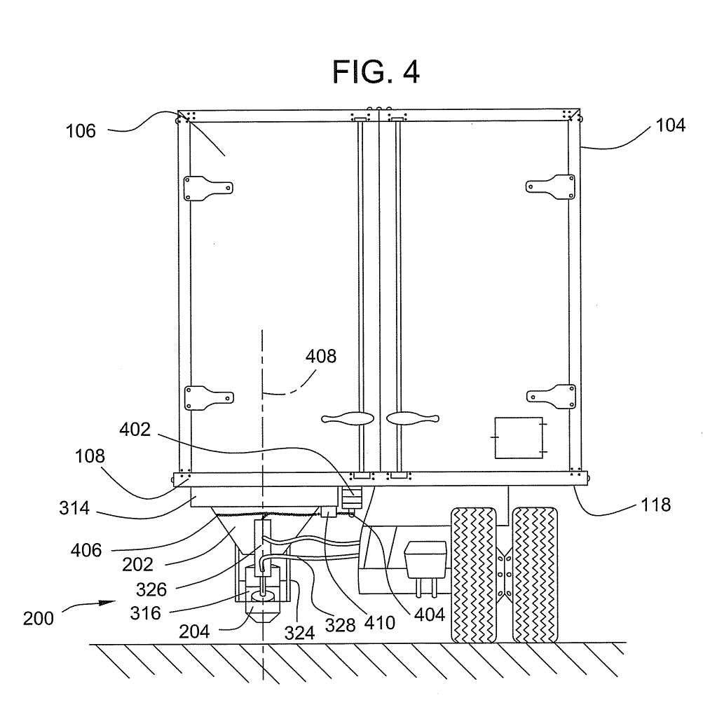

A partial breakaway of the trailer 104 showing the boom 204 in a stowed position beneath the floor 108 is shown in FIG. 4. One advantage of mounting the delivery system 200 beneath an otherwise typical band trailer is the ability to stow the boom 204 fully below the bottom side 118 of the floor 108. While the boom 204 is in the stowed position, no portion of the delivery system 200 extends out beyond the edge of the floor 108, allowing the trailer 104 to travel safely and legally on public roads and highways.

More specifically, storage of the boom 204 under the trailer 104 may be accomplished by retracting the cylinder 326 to an appropriate extent, bringing the boom 204 in a generally horizontal position. Subsequently, the funnel 202 may be rotated such that the boom 204 swings under the floor 108 in a position generally parallel to the centerline 208 of the trailer 104 (the centerline visible in FIG. 2). Rotation of the funnel 202 may be accomplished by any suitable arrangement. In the embodiment described, a hydraulic motor 402 is connected via a bracket (not shown) to the bottom side 118 of the floor 108. A rotating sprocket 404 connected to the motor 402 is engaged or meshed with a drive chain 406 engaging and surrounding the funnel 202. Actuation of the motor 402 in either direction rotates the sprocket 404, which pulls the chain 406 in one direction. The chain 406 is coupled to the funnel 202 such that the entire assembly, which broadly includes the offset funnel 202 and boom 204, rotates with respect to a vertical plane 408 that includes the centerlines A and B passing through the mouth opening 311 and spout opening 321 of the offset funnel 204. In the embodiment shown, rotation of the offset funnel 204 occurs about the centerline A passing through the center of the mouth opening 311 but other configurations are possible. Moreover, a chain tensioning device 410 is arranged to maintain tension in the chain 406 and to keep the chain 406 engaged with the sprocket 404. The device 410 is capable of taking up slack in the chain 406 that is created due to rotation of the irregular or offset-cone shape of the funnel 204.

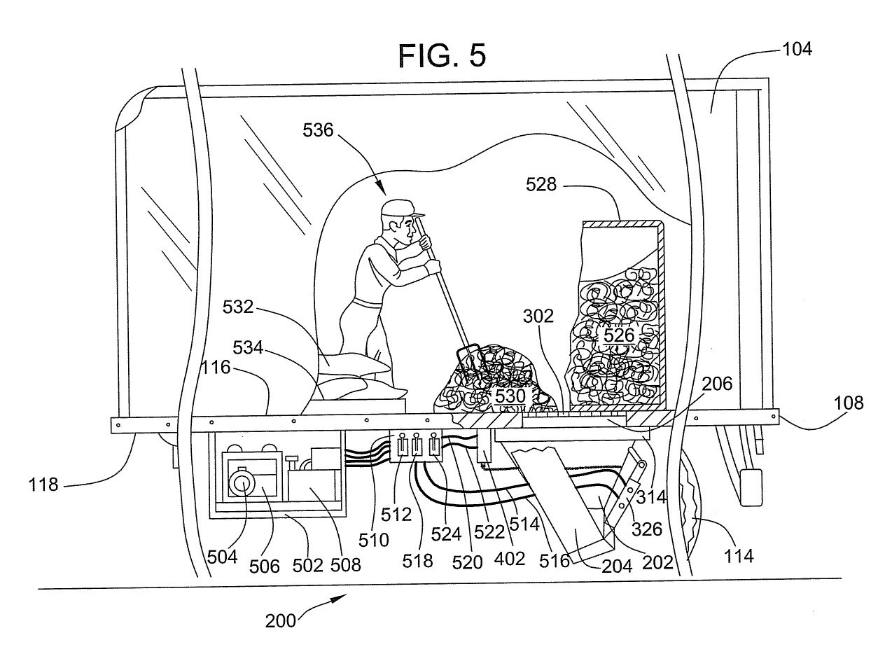

A partial cross section of the trailer 104 is shown in the segmented view of FIG. 5. In this view, the mechanical components and controls providing the power to move the various actuators can be seen. A platform 502 is connected to the bottom side 118 of the floor 108. The platform 502 may be bolted with brackets or alternatively welded onto the trailer 104. A small engine or electric motor 504 connected to a hydraulic pump 506 pumps hydraulic fluid from a reservoir 508. As can be appreciated, any suitable power transmission device may be used instead of a hydraulic system, for example, a pneumatic or mechanical arrangement may be used in conjunction with appropriate actuators. In the illustrated embodiment, the pump 506 pumps hydraulic fluid to an arrangement of control valves 510.

The control valves 510 are configured for selectively supplying pressurized hydraulic fluid to various actuators in the delivery system 202. A first or lift control valve 512 may be arranged for two-way gating of pressurized fluid flow to and from the hydraulic cylinder 326 via first and second hoses 514 and 516. During operation, the lift control valve 512 may selectively connect either side of a piston included in the cylinder 326 with either a source of fluid or a drain, causing the piston to move within the cylinder 326 in the desired direction. In a similar fashion, a second or steer control valve 518 may selectively gate a pressurized fluid flow through the hydraulic motor 402 via third and fourth hoses 520 and 522 to cause rotation of the funnel 202 in either direction. Finally, a third or supply control valve 524 may selectively gate a flow of pressurized fluid to a conveyor motor (not shown) operating to sustain rotation of the conveyor belt (described above and shown in FIG. 3). Each of the control valves 510 may be mechanically or electrically controlled. In the case of electrical control, the position or setting of one or more of the control valves 510 may be actuated by an electrical actuator, for example, an electrical solenoid, operated by electrical switches. As can be appreciated, the control valve arrangement 510 may be positioned anywhere on the band trailer or even within the cab of the truck, or even by remote control in the case of electrical actuation of the valves, to permit safe and effective operation of the delivery system 200 by the user.

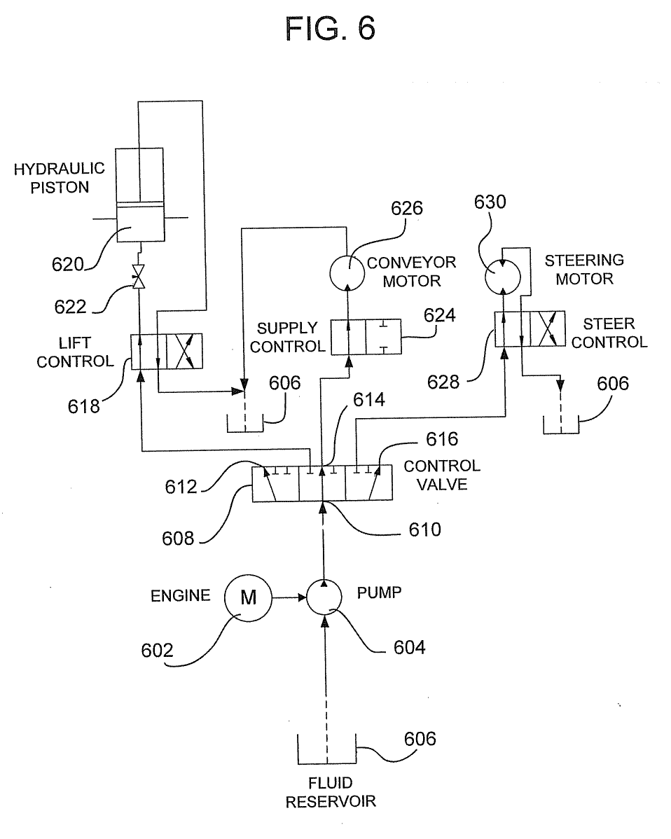

A hydraulic diagram for a system 600 is shown in FIG. 6. The system 600 is one example for a hydraulic system suited for operating the delivery system 200. The system 600 includes an engine or motor 602 operably connected to a pump 604. The pump 604 is arranged to pump fluid from a reservoir 606 to a three-position four-port control valve 608. The control valve 608 has an inlet port 610 and three outlet ports. A user may select to route the flow of fluid from the pump 604 into one of a first outlet port 612, a second outlet port 614, or a third outlet port 616, while blocking flow to the two unselected ports, by simply moving the control valve 608 to a desired position either by mechanical or electrical actuation devices.

The first outlet port 612 of the control valve 608 is connected to a two-position four-port lift control valve 618. The lift control valve 618 is arranged to fluidly connect either side of a lift piston 620 with the fluid supply from the control valve 608 and a drain to the reservoir 606. A user can selectively raise or lower the lift piston 620 by appropriately setting the lift control valve 618 either mechanically or electrically to a desired position. An optional needle valve 622 may be connected between the lift control valve 618 and the piston 620 to permit fine control and unpowered lowering of the piston 620.

The second outlet port 614 of the control valve 608 is connected to a two-position two-port supply control valve 624. The supply control valve 624 selectively connects a hydraulic motor 626 operating the conveyor, as described above, to a flow of actuating fluid from the pump 604. Fluid passing through the conveyor motor 626 operates to rotate the conveyor before returning to the reservoir 606.

The third outlet port 616 of the control valve 608 is connected to a two-position four-port control valve 628. The control valve 628 is arranged to fluidly connect either side of a reversible hydraulic motor 630 with the fluid supply from the control valve 608 and a drain to the reservoir 606. A user can selectively cause the motor 630 to reorient the funnel with respect to the truck, as described above, by appropriately setting the position of the control valve 628 either mechanically or electrically.

The delivery system for unloading aggregate material from a truck finds special advantage when used for the transportation and delivery of aggregates between a source or distributor directly to the location of use by the customer. For example, transporting aggregate seed material from a source or distributor to a farm typically involves travel over public roads and highways. Thereafter, the customer has to unpack the seed and subsequently reload the seed into a field cart used for gradually depositing the seed into a planter machine. One example of a planting machine is described in U.S. Pat. No. 2,584,322 titled “Mechanized Seed Distributor,” issued on Feb. 5, 1952 to H. J. Baldwin et al. This patent describes a mechanical planting vehicle coupled to a truck or cart. The cart gradually transfers the seedling material via conveyor to the vehicle spreading and planting the seedlings across the field. In contrast, use of the present system is efficient in labor and time because the truck carrying the seed to the customer can also be used in place of a seed cart to supply the aggregate seed material directly to a mechanical planter. Thus, the aggregate seed need only be loaded onto a truck once, at the distributor, and be off loaded directly at the point of use by the customer. Moreover, use of the band trailer is flexible in as much as different packaging arrangements for the seed material can be used with ease.

Returning now to FIG. 5, the trailer 104 is shown in two potential modes of operation during dispensation of aggregate seed material at the customer's location. Two alternative seed packaging configurations are shown for illustration. In a first configuration, aggregate seed material 526 is packaged in a large, typically plastic, bin 528. The bin 528 has an opening 530 positioned above the opening 206 in the floor 108 of the trailer 104. During off-loading of the aggregate 526, the trailer 104 may be in motion adjacent to a planting machine (not shown) and the boom 202 positioned such that aggregate falling out of the bin 528 passes through the grate 302 and opening 206 into the funnel 202. From the funnel 202, the aggregate 526 is routed onto the conveyor within the boom 202 and transported directly into a receiver opening of the planting machine. This arrangement is advantageously enabled by the positioning of the bin 528 over the opening 206 while the bin 528 rests on the flat floor 108 of the trailer 104. Alternatively, in cases when aggregate seed material 530 is packaged in bags 532 loaded into the trailer 104 arranged on pallets 534, a worker 536 may manually open the bags 532 to retrieve the aggregate 530. The bags 532 can simply be emptied onto the floor 108 and pushed into the opening 206 and onto the conveyor.

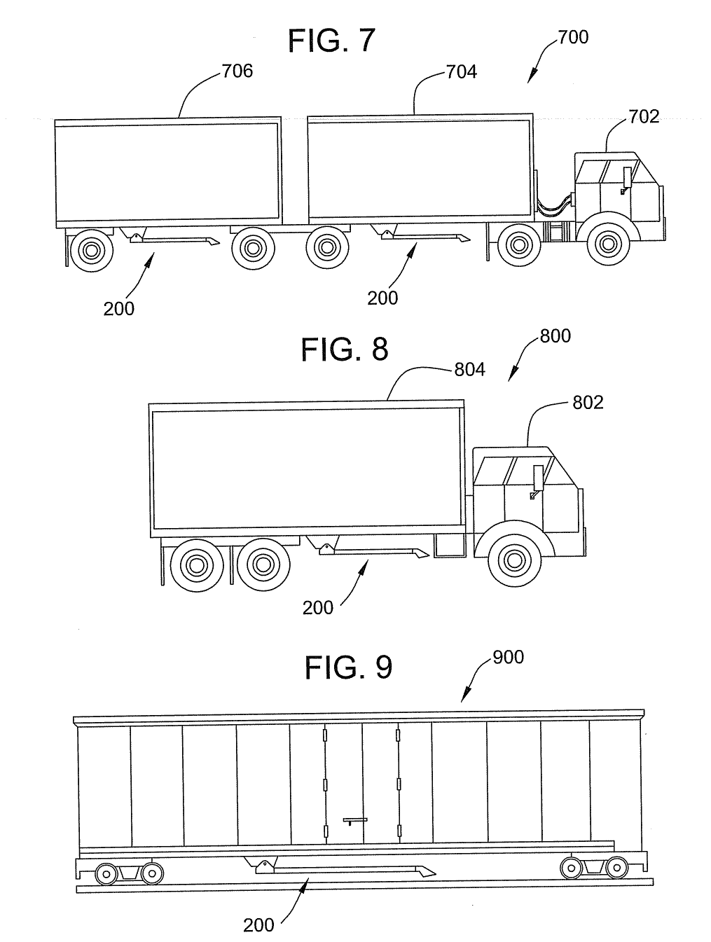

As can be appreciated, the modular nature of the delivery system 200 lends itself for attachment to any type of truck or other vehicles having cargo transportation areas with generally flat floors. Exemplary implementations of the delivery system 200 for use with land and rail vehicles are shown in FIG. 7, FIG. 8, and FIG. 9. Starting with FIG. 7, a truck 700 includes a cab 702 connected with a band trailer 704, which in turn is connected to a trailer 706. Each trailer 704 and 706 is equipped with a delivery system 200 as described above. Because of the flexibility of attachment of the delivery system and associated mechanical components to any flat floor surface of a vehicle, the truck 700 is advantageously able to service more than one customer for any single trip from the distributor. A customer may, for example, receive the trailer 704 at the customer's facility and use it to not only temporarily store the aggregate, but can also attach the trailer 704 to any other form of motive conveyance for use in the field in conjunction with a seed planting machine.

In the embodiment of FIG. 8, the delivery system 200 is shown attached to a typical box truck 800. The truck 800 includes a cab 802 connected to a box 804 disposed on a single frame 806. The truck 800 may advantageously be used for short hauls of aggregate to customers, and may even be a truck belonging to a customer temporarily fitted with the delivery system 200. In this scenario, a distributor or seller of aggregate material may lease or lend modular units of delivery systems 200 for use by customers desiring to use their own trucks to transport the aggregate to their facilities. When a customer arrives at the distributor's facility in a truck optionally having a preformed opening in the floor of the cargo area, a distributor may simply load the truck with the aggregate material cargo and retrofit the delivery system onto the truck, thus avoiding the transportation costs or assets associated with delivery of the product to the customers.

In the embodiment of FIG. 9, the delivery system 200 is shown attached to a rail car 900. The rail car 900 is shown as a typical boxcar suited for transportation and delivery of aggregate material in containers or pallets alongside a track. In applications requiring delivery of aggregate material by rail to installations not suited for that purpose, the rail car 900 is advantageously capable of carrying the aggregate material to its destination and automatically depositing it in any location adjacent to the track efficiently and expeditiously.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A land vehicle for transporting and distributing aggregate material, comprising:
a chassis including a floor portion, the floor portion having a flat deck surface forming an opening extending through the floor portion;
a funnel rotatably connected to the floor portion, the funnel having a mouth opening communicating with the opening in the floor portion and a spout opening;
a boom hingeably connected to the funnel, the boom being fully stowable beneath the floor portion of the chassis when not in use, the boom including a conveyor operable along a major dimension of the boom, the conveyor having a receiving end proximate to and below the spout opening;
wherein a flow of the aggregate material is adapted to enter the mouth opening of the funnel, through the opening in the floor portion, and transfer to the receiving end of the conveyor through the spout opening.

2. The land vehicle of claim 1, wherein a first centerline of the mouth opening is disposed at a distance from a second centerline of the spout opening.

3. The land vehicle of claim 1, further including a rim surrounding the mouth opening of the funnel, and an annular flange forming a ledge, the annular flange connected to the floor portion of the chassis with the ledge surrounding the opening, wherein the ledge and the rim cooperate to rotatably support the funnel to the floor portion.

4. The land vehicle of claim 3, further comprising a collar disposed around the ledge and the rim, wherein a bushing is disposed between the clamp and the ledge to reduce sliding friction when the funnel is rotating with respect to the chassis.

5. The land vehicle of claim 1, wherein the opening in the floor portion is disposed offset from a centerline of the land vehicle.

6. The land vehicle of claim 1, further comprising a linear actuator coupled to a distal end of the boom proximate to the receiving end and the funnel, the linear actuator operating to selectively pivot the boom with respect to the funnel.

7. The land vehicle of claim 1, further comprising a prime mover connected to a pump, the pump operating to pressurize fluid for actuating at least one actuator, the at least one actuator operating to either rotate the funnel, pivot the boom, or operate the conveyor.

8. The land vehicle of claim 1, further comprising a motor having a driven sprocket engaged with a chain, the chain extending around and coupled to the funnel, such that actuation of the motor operates to rotate the funnel with respect to the chassis.

9. The land vehicle of claim 1, wherein the conveyor includes a conveyor belt having a plurality of protrusions formed along its length, each protrusion adapted to act as a scoop to promote efficient motion of the aggregate material along the boom.

10. A modular delivery system for unloading aggregate material from a land vehicle, the delivery system adapted for operable connection to the land vehicle, the system comprising:
an annular flange having a ledge, the ledge extending peripherally around the annular flange, the annular flange adapted for connection beneath a floor portion of the vehicle;
a funnel having a mouth opening and a spout opening, the funnel including a rim surrounding the mouth opening, the rim disposed adjacent to the ledge when the delivery system is installed under the vehicle;
a collar disposed to rotatably connect the ledge with the rim;
an elongate boom, the boom having a receiving end and a delivery end, the boom operably including a conveyor mechanism extending between the receiving end and the delivery end;
the boom hingeably connected to the funnel such that the receiving end is disposed to receive aggregate material from the spout opening,
the boom and funnel being pivotingly rotatable about the vehicle such that the boom is capable of two degrees of motion with respect to the vehicle when the delivery system is connected to the vehicle; and
the boom being movable to a storage position beneath the vehicle such that the boom is entirely under the floor portion of the vehicle when in the storage position.

11. The delivery system of claim 10, further comprising a motor operable to advance the conveyor mechanism within the boom.

12. The delivery system of claim 10, further comprising a prime mover connected to a pump, the pump operating to pressurize fluid for actuating at least one actuator, the at least one actuator operating to either rotate the funnel, pivot the boom, or operate the conveyor.

13. The delivery system of claim 12, further comprising a control valve operating to selectively route a flow of the pressurized fluid to first, second, and third output ports, the first output port connected to a hydraulic piston operating to raise and lower the boom, the second outlet port connected to a conveyor motor operating the conveyor, and the third outlet port connected to an additional hydraulic motor operating to rotate the funnel.

14. The delivery system of claim 13, further including:
a two-position four-port lift control valve connecting the first outlet port and a drain selectively to each of two ends of the hydraulic piston;
a two-position two-port supply control valve connecting the second outlet port and the drain selectively to the conveyor motor; and
a two-position four-port steer control valve connecting the third outlet port and the drain selectively to the additional hydraulic motor.

15. The delivery system of claim 10, further comprising a motor having a driven sprocket engaged with a chain, the chain extending around and coupled to the funnel, such that actuation of the motor operates to rotate the funnel when the funnel is connected to the vehicle.

16. A method for unloading aggregate material from a land vehicle, comprising:
rotating a funnel about a vertical axis, the funnel rotatably connected to a floor portion of the vehicle;
pivoting a boom with respect to the funnel, the boom pivotally connected to the funnel and including a conveyor;
passing a flow of aggregate through an opening formed in the floor portion of the vehicle into the funnel;
collecting the flow of aggregate in the funnel;
routing the flow of aggregate to a receiving end of the boom such that the flow of aggregate falls onto the conveyor;
transporting the flow of aggregate along the conveyor to a delivery end of the boom.

17. The method of claim 16, further comprising storing the boom completely beneath the floor portion of the vehicle when not in use, the storing accomplished by pivoting the boom to a substantially horizontal position and rotating the funnel such that the boom becomes substantially parallel to a centerline of the vehicle

18. The method of claim 16, further comprising storing an amount of aggregate in a container within the vehicle, the container having an opening allowing egress of aggregate therefrom, wherein the step of passing a flow of aggregate through the opening in the floor portion of the vehicle includes placing the container above the opening in the floor such that the opening of the container is at least partially aligned with the opening in the floor.

19. The method of claim 16, further comprising pressurizing a fluid with a pump, and routing a flow of pressurized fluid to at least one actuator operating to either rotate the funnel, pivot the boom, or operate the conveyor.

20. The method of claim 19, wherein the at least one actuator is one of a hydraulic motor and a hydraulic piston.
